(19) United States
(12) Patent Application Publication
(10) Pub. No.: US 2022/0129062 A1
(43) Pub. Date: Apr. 28, 2022

(54) Projection Method, Medium and System for Immersive Contents

(71) Applicant: Hangzhou Rulei Technology Co., Ltd., Hangzhou City (CN)

(72) Inventors: Xiaolei Wang, Hangzhou City (CN); Chen Sun, Hangzhou City (CN)

(21) Appl. No.: 17/503,426

(22) Filed: Oct. 18, 2021

(30) Foreign Application Priority Data
Oct. 28, 2020 (CN) 202011169936.9
Oct. 28, 2020 (CN) 202011169940.5
Jan. 29, 2021 (CN) 202011175692.5

(51) Int. Cl. G06F 3/01; G06T 17/00; G06T 15/20; H04N 9/31

(52) U.S. Cl. CPC G06F 3/011; H04N 9/3179; G06T 15/20; G06T 17/00

(57) ABSTRACT

A projection method, medium and system for immersive contents, wherein the projection method includes obtaining the attitude information of projection equipment in the space; building a virtual 3D scene model according to the file to be projected, building a virtual camera and a virtual head auditory model in the virtual 3D scene model, mapping the virtual camera and the virtual head auditory model to the projection equipment, calculating and obtaining the projected image and audio data under the current attitude information; or confirming the projected image under the current attitude information according to the preprocessed image or audio file, and calculating the audio data under the current attitude information by the head-related transformation function; or including the objects whose state or position can be changed after receiving an interactive instruction in the virtual 3D scene model, and outputting the projected image and the audio data under the current attitude information.

### TECHNICAL FIELD

The present invention belongs to the field of projection technology, and relates to a projection method, medium and system for immersive contents.

### BACKGROUND ART

Immersive contents include panoramic images or panoramic videos. The panoramic views for real scenarios are reproduced usually by recording the scene views in all possible directions through an omni-directional camera or a set of cameras or virtually produced through 3D creation software. Immersive contents are increasingly used in marketing or advertising to attract more consumers because they can make commodities and services more alive. Immersive contents are also used in musical performances, theaters, concerts, etc., to have a larger audience not having to attend activities. Immersive contents are also applicable to game, entertainment and education.

In addition to the recording of 360° videos, the immersive content producing technology also requires the specific post-production and three-dimensional (3D) animation software as well as the computer application allowing to project images by equirectangular projection, cylindrical projection, stereographic projection, fisheye projection, cube mapping projection, etc.

Up to now, the most popular and only accessible reproduction technology for immersive contents is the use of virtual reality (VR) glasses. However, VR glasses only allow the wearer to enjoy the contents, but isolate the user from the real environment. Moreover, VR glasses are limited to one person and cannot be used for more users to watch the same immersive content at the same time.

Displaying immersive contents in the real space can circumvent the defects of VR glasses. The existing solution, for example, the Chinese patent of CN107592514A discloses a panoramic projection system and method. The system has several projectors, and through a projection algorithm, segments the panorama image to be displayed into small images and projects them respectively with the projectors onto several walls of the projection room. A plurality of projected small images are stitched into a continuous immersive image. To achieve a large projection area, the solution requires several projectors and accordingly a high hardware cost. Moreover, the system requires a pre-installation, precise position calibration and complex operation.

For another example, the Chinese patent of CN109076203A discloses a projection system for immersive contents, which projects images with a horizontal view angle of 180° in the real space by using a projector with a fisheye lens. In order to achieve a large projection area while keeping enough brightness of the projected image, the system requires high power for the projector. Moreover, a single projector can only project an image with a 180° projector. To cover a 360° panorama, two projectors are required. The solution has the same problem as that of CN107592514A.

The existing immersive content projection solutions usually require several projectors to project different small images and stitch them into a large immersive content in order to present a 360° panorama image. In order to project a clear image on the large-area wall, the requirements for the power and brightness of the projector are high; more hardware devices are required, and the cost is high. In order to stitch small images into panoramic immersive content, the user requires to install and calibrate projectors in advance so that they can be precisely aligned for image stitching. These technical disadvantages limit the usage scenarios of existing solutions. Therefore, the existing solutions are only suitable for fixed and long-time operations, such as for commercial exhibitions, museums, science and education museums, etc., and are difficultly applicable to families, schools, small-scale entertainment and other occasions. The panoramic projection of 3D contents is more complex and is often achieved with the help of more devices.

### CONTENTS OF THE INVENTION

In order to solve the technical problems in the prior art, such as high requirements for the power and brightness of the projectors to project clear images on the large-area wall, more hardware devices and higher cost, preinstallation and calibration of projectors to stitch small images into a panoramic immersive content and accurately align and stitching, the present invention proposes a projection method and system for immersive contents.

First, a projection method for immersive contents includes:

S1a: Obtaining the attitude information of the projection equipment in the space, wherein, the attitude information includes the spatial attitude and heading of the projection equipment;

S2a: Building a virtual 3D scene model according to the file to be projected, and building a virtual camera and a virtual head auditory model in the virtual 3D scene model;

S3a: Mapping the virtual camera and the virtual head auditory model to the projection equipment, calculating and obtaining the projected image and audio data under the current attitude information; and

S4a: Outputting the projected image and the audio data under the current attitude information; or

S1b: Obtaining the attitude information of projection equipment in the space, wherein, the attitude information includes the spatial attitude and heading of the projection equipment;

S2b: Confirming the projected image under the current attitude information according to the preprocessed image or audio file;

S3b: Calculating the audio data under the current attitude information by using the head-related transformation function; and

S4b: Outputting the projected image and the audio data under the current attitude information; or

S1c: Obtaining the attitude information of the projection equipment in the space, wherein, the attitude information includes the spatial attitude and heading of the projection equipment;

S2c: Building a virtual 3D scene model according to the file to be projected, and building a virtual camera and a virtual head auditory model in the virtual 3D scene model, wherein, the virtual 3D scene model includes an object which can change state or position after receiving an interactive instruction;

S3c: Mapping the virtual camera and the virtual head auditory model to the projection equipment, calculating and obtaining the projected image and/or audio data under the current attitude information and/or the interactive instruction; and

S4c: Outputting the projected image and the audio data under the current attitude information and/or the interactive instruction.

Preferably, the 3D scene model comprises a foreground object, a background object and a sound source, and the positions and appearances of the foreground object and the background object change as time changes.

Preferably, the object(s) set to change the state or position after receiving the interactive instruction is one or more of the foreground objects.

Preferably, the preprocessed image or audio file includes a static panorama or a panoramic video.

Preferably, the attitude information of the Step S1a, S1b or S1c is obtained by an attitude sensor set on the projection equipment through the attitude estimation, which is based on the Kalman filter sensor fusion algorithm.

Preferably, the attitude sensor is a 6-axis or 9-axis sensor, comprising an acceleration sensor, an angular velocity sensor and a geomagnetic data sensor.

Preferably, the virtual camera has the same field of view and aspect ratio of the imaging plane as the projection equipment, and the attitude information of the virtual camera and the virtual head auditory model is the same as that of the projection equipment.

Preferably, the projected image under the current attitude information is obtained by computer 3D graphics computing, and the audio data is obtained by head-related transformation function computing.

Preferably, the projection equipment rotates in the space to project the projected image and the audio data at the corresponding position of the preprocessed image or audio file at different positions in the space.

Preferably, in the step S3c, the projected image and/or audio data under the interactive instruction are calculated as follows:

Responding to the axis of the virtual camera to intersect with the foreground object, which is set to an object capable of changing the state or position after receiving the interactive instruction, and recording the object as a virtual object to be operated;

Responding to the user to send the interactive instruction, and switching the virtual object to be operated to an interactive state if the virtual object to be operated exists, wherein, the interactive state includes morphological change, position change, size change or their combination;

Responding to the user to release the interactive instruction, restoring the virtual object to be operated to the normal state if the virtual object to be operated exists, and emptying the record of the virtual object to be operated.

Second, a computer readable storage medium, on which one or more computer programs are stored and the computer processor executes the method in the first aspect.

Third, a projection system for immersive contents, comprising:

projection equipment for receiving the image to be projected and transmitting the image to the space surface;

An attitude sensor module used for obtaining the attitude information of the projection equipment in the current space, wherein, the attitude information includes the spatial attitude and heading of the projection equipment; and

A first processor module used for building a virtual 3D scene model according to the file to be projected, building a virtual camera and a virtual head auditory model in the virtual 3D scene model, mapping the virtual camera and the virtual head auditory model to the projection equipment, obtaining the projected image and the audio data under the current attitude information, and determining the projected image of the projection equipment under the current attitude information according to the different attitude information when the projection equipment rotates in the space; or

A second processor module used for determining the projected image of the projection equipment under the current attitude information according to different attitude information of the projection equipment when the projection equipment rotates in space; or

A third processor module used for building a virtual 3D scene model according to the file to be projected, and building a virtual camera and a virtual head auditory model in the virtual 3D scene model, wherein, the virtual 3D scene model includes an object which can change the state or position after receiving an interactive instruction; mapping the virtual camera and the virtual head auditory model to the projection equipment, obtaining the projected image and the audio data under the current attitude information and/or the interactive instruction, and determining the projected image and the audio data of the projection equipment under the current attitude information and/or the interactive instruction according to the different attitude information and/or the interactive instruction when the projection equipment rotates in the space.

Preferably, the projection equipment also comprises an audio output module for outputting the audio of at least one channel or stereo audio of at least two channels.

Preferably, the system also comprises:

An interactive module used for receiving the interactive instructions made by the user.

Preferably, the interactive module comprises a button, a joystick or a gamepad on the system, and the interactive instructions include click, tilting or different button instructions.

Preferably, the third processor module is also used for:

Responding to the axis of the virtual camera to intersect with the foreground object, which is set to an object capable of changing the state or position after receiving the interactive instruction, and recording the object as a virtual object to be operated;

Responding to the user to send the interactive instruction, and switching the virtual object to be operated to an interactive state if the virtual object to be operated exists, wherein, the interactive state includes morphological change, position change, size change or their combination;

Responding to the user to release the interactive instruction, restoring the virtual object to be operated to the normal state if the virtual object to be operated exists, and emptying the record of the virtual object to be operated.

According to the technical proposal, the projection system, medium and method for immersive contents provided by the present invention constructs a virtual 3D scene model containing background and a plurality of foreground objects, a virtual camera is arranged in the center of the virtual scene, the field of view of the virtual camera is the same as that of the projection equipment, the aspect ratio of the imaging plane of the virtual camera is the same as that of the image projected by the projection equipment, and a virtual head auditory model is arranged in the center of the virtual scene; the current attitude and the relative heading are calculated by the current attitude, heading and initial state of the equipment and set to the attitude and heading of the virtual camera and the virtual head, the image of the virtual scene in the virtual camera is calculated and projected, audio synthesized in the virtual head auditory model by sounds from sound sources in the virtual scene are calculated and played.

The projection system, medium and method for immersive contents provided by the present invention uses projection equipment which can move in the space and locates the current spatial attitude and heading of the projection equipment through the attitude sensor, so as to project different contents.

The projection system, medium and method for immersive contents provided by the present invention locates the attitude and heading of the current projection through the attitude sensor by skillfully using the attitude sensor, the interactive device and the projection equipment, changes the position and state of virtual objects according to the user operation received by the interactive device, calculates and projects the contents varying with the attitude and heading.

As the projection content is the same only in the same direction and angle, once the attitude sensor locates the change of attitude, the projection content of the projection area will be changed. The change of projection content is not simple content change, but a continuous one. Thus, as the projection equipment rotates in the space, the images projected in different directions can be stitched into a complete 360° surround panorama. The projection lens only projects part of the area at a time, and the projection content can be changed by rotating the projection lens. The method is similar to exploration, constantly adjusting the projection lens to explore the whole projection content.

### BRIEF DESCRIPTION OF THE DRAWINGS

In order to more clearly describe the embodiments of the present invention or the technical proposal of the prior art, the drawings to be used in the embodiments or the prior art are briefly introduced below. In all attached drawings, similar elements or parts are generally identified with similar drawing reference signs. The elements or parts in the drawings are not always drawn to the actual scale.

FIG. 1 shows a flow chart of a projection method for immersive contents for one embodiment of the present invention.

FIG. 2 shows a flow chart of a projection method for immersive contents for one specific embodiment of the present invention.

FIG. 3 shows a framework diagram of a projection system for immersive contents for one embodiment of the present invention.

FIG. 4a-4d show effect drawings of a projection system for immersive contents for one embodiment of the present invention.

FIG. 5 shows a flow chart of a projection method for immersive contents for one embodiment of the present invention.

FIG. 6 shows a flow chart of a projection method for immersive contents for one specific embodiment of the present invention.

FIG. 7 shows a framework diagram of a projection system for immersive contents for one embodiment of the present invention.

FIG. 8a-8b show effect drawings of a projection system for immersive contents for one specific embodiment of the present invention.

FIG. 9 shows a flow chart of an interactive method for immersive contents for one embodiment of the present invention.

FIG. 10 shows a flow chart of an interactive method for immersive contents for one specific embodiment of the present invention.

FIG. 11 shows a framework diagram of an interactive system for immersive contents for one embodiment of the present invention.

FIG. 12a-12d show effect drawings of an interactive system for immersive contents for one specific embodiment of the present invention.

FIG. 13 shows a structural diagram of a computer system suitable for the implementation of electronic equipment for one embodiment of the present invention.

### DETAILED DESCRIPTION OF THE EMBODIMENTS

The embodiments of the technical proposal in the present invention are described in detail below in combination with the attached drawings. The following embodiments are used only to more clearly illustrate the technical proposal of the present invention and are therefore only examples, and shall not limit the scope of protection of the present invention. It should be noted that the technical or scientific terms used in the present invention shall be ordinary meanings understood by technicians in the field to which the present invention belongs unless otherwise stated.

It should be understood that the terms “comprise” and “contain” indicate the presence of the described characteristics, entirety, steps, operation, elements and/or components when being used in the specification and the claims, but do not exclude the presence or addition of one or more other characteristics, entirety, steps, operation, elements, components and/or their combination.

It should also be understood that the terms used in this specification of the present invention are intended only to describe the particular embodiments and are not intended to limit the present invention. As used in the specification and claims of the present invention, the singular forms “a/an”, “one” and “the” are intended to include the plural form unless otherwise indicated clearly in the context.

As used in this specification and the claims, the term “if” may be interpreted as “when . . . ” or “once” or “responding to determine” or “responding to detect” in context. Similarly, the phrases “if determined” or “if the condition or event] is detected” can be interpreted as “once determined” or “responding to determine” or “once the condition or event] is detected” or “responding to detect the condition or event]” depending on the context.

### Embodiment 1

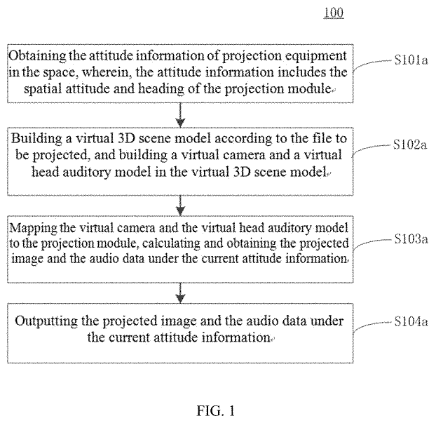

According to a projection method for immersive contents for one embodiment of the present invention, FIG. 1 shows a flow chart of a projection method for immersive contents according to one embodiment of the present invention. As shown in FIG. 1, the method 100 comprises the following steps:

S101a: Obtaining the initial attitude information of the projection equipment in the space, wherein, the attitude information includes the spatial attitude and heading of the projection equipment. The initial attitude information of the projection equipment facilitates to analyze what image needs to be output under the current attitude of the equipment.

In a specific embodiment, the attitude information can be obtained by the attitude sensor set on the projection equipment. The attitude sensor can be a 6-axis attitude sensor containing 3-axis acceleration and 3-axis angular velocity, or a 3-axis geomagnetic sensor can be added to form a 9-axis sensor. When the 6-axis attitude sensor is used, the accurate attitude of the equipment and the heading (also known as yaw) relative to the initial state can be obtained; when the 9-axis attitude sensor is used, the accurate attitude of the equipment and the absolute heading relative to the earth can be obtained.

In a specific embodiment, the projection equipment generally comprises a light source, a display component and an optical lens group. Available projection technologies include single-chip LCD (liquid crystal display) projection, 3LCD projection, DLP (digital light processing) projection and LCOS (reflective miniature LCD) projection, etc. The suitable projection technology equipment is selected according to the projection environment and the image requirements.

S102a: Building a virtual 3D scene model according to the file to be projected, and building a virtual camera and a virtual head auditory model in the virtual 3D scene model. The virtual 3D scene model can be used to pre-calculate and obtain the image or audio output relative to the virtual camera and the virtual head auditory model, facilitating to output in the projection equipment.

In a specific embodiment, a virtual 3D scene model is built according to the image and audio information in the file to be projected, and a background object, a foreground object and a sound source are contained in the scene; the positions and appearances of the background object and foreground object change with time; a virtual camera and a virtual head auditory model are built, which are located in the center of the virtual scene and whose initial attitude and heading are default attitude and heading.

S103a: Mapping the virtual camera and the virtual head auditory model to the projection equipment, calculating and obtaining the projected image and the audio data under the current attitude information. The image and audio information in the virtual camera and the virtual head auditory model can be directly obtained on the projection equipment through the mapping relation, and the corresponding image and audio can be projected based on different attitude information.

In a specific embodiment, the virtual camera and the virtual head auditory model are mapped to the projection equipment as follows: the field of view of the virtual camera is the same as that of the projection equipment, the aspect ratio of the imaging plane for the virtual camera is the same as that of the projected image on the projection equipment; the virtual head auditory model is built, and the initial position, attitude and heading of the virtual head auditory model are the same as that of the virtual camera.

In a specific embodiment, the image of the virtual scene in the virtual camera can be calculated according to the computer 3D graphic method; the audio synthesized in the virtual head auditory model by sounds from sound sources in the virtual scene are calculated according to the method based on head-related transformation function (HRTF).

S104a: Outputting the projected image and the audio data under the current attitude information. Finally, the projected image and the audio data under the current attitude information are outputted on the space surface through the projection equipment to obtain the immersive 3D projection content.

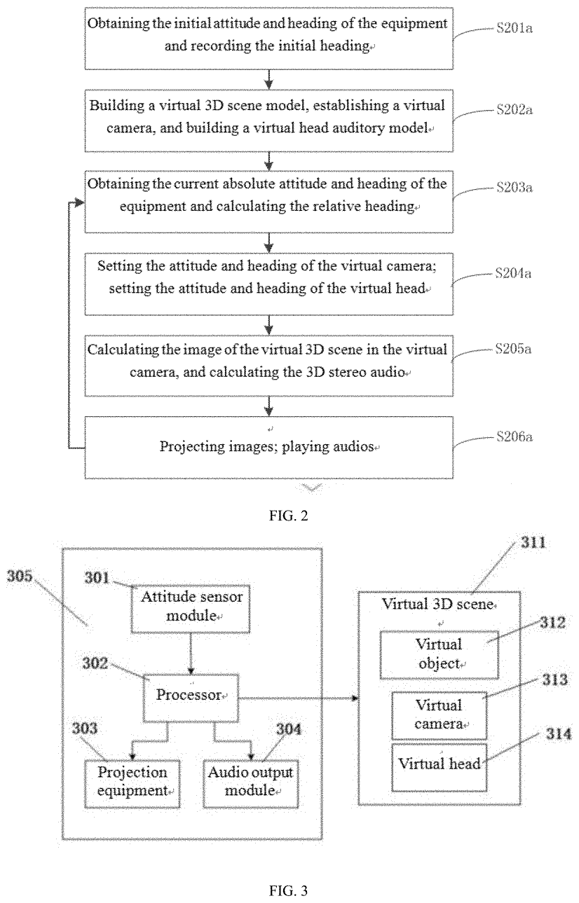

FIG. 2 shows a projection method for immersive contents according to a specific embodiment of the present invention. As shown in FIG. 2, the method includes the following steps:

Step 201a: Obtaining the initial attitude and heading of the equipment from attitude sensor after the system is started, and recording the initial heading of the equipment.

Step 202a: Building a virtual 3D scene model, in which the scene contains a background object, a foreground object and a sound source and the positions and appearances of the background object and foreground object change over time; establishing a virtual camera, which is located in the center of the virtual scene, whose initial attitude and heading are default attitude and heading, whose field of view is the same as that of the projection equipment, whose aspect ratio of the imaging plane is the same as that of the image projected by the projection equipment; building a virtual head auditory model, whose initial position, attitude and heading are the same as that of the virtual camera.

Step 203a: Obtaining the current absolute attitude and heading of the equipment. Optionally, calculating the current heading of the equipment relative to the initial state according to the initial heading recorded in Step 201a.

Step 204a: Setting the attitude and heading of the virtual camera to the attitude and heading obtained in Step 203a; setting the attitude and heading of the virtual head model to be the same as that of the virtual camera.

Step 205a: Calculating the image of the virtual scene in the virtual camera by the computer 3D graphics method; calculating the audio synthesized in the virtual head auditory model by sounds from sound sources in the virtual scene by the method based on head-related transformation function (HRTF).

Step 206a: Projecting the current image by using the image obtained in Step 105a; playing audio by using the audio obtained in Step 205a.

When the attitude of the projection equipment changes, repeat Step 203a so that the projection equipment changes the projected image and the played sound with the change of attitude and heading in real time.

FIG. 3 shows a block diagram of a projection system for immersive contents according to a specific embodiment of the present invention. As shown in FIG. 3, this projection system comprises an attitude sensor 301, a processor 302 and projection equipment 303, wherein, the attitude sensor 301 can obtain the current attitude and heading of the system in the space; the processor module 302 has a certain operational capability to calculate the image that the system needs to project under the current attitude and heading according to the attitude and heading of the system and send the image to the projection equipment 303, calculates the audio that the system needs to play under the current attitude and heading, and sends the audio to an audio output module 304 on the projection equipment 303; the projection equipment 303 can receive the image to be projected and project the image onto the surface of the real space by using the optical principle.

In a specific embodiment, the audio output module 304 can output the audio of at least one channel or stereo audio of at least two channels, which can be a speaker or an earphone. The system also comprises a casing 305, containing a part which can be held by hands or fixed to the body of the user or other moving parts. When the system is used, the attitude and heading of the attitude sensor 301 in the space change by rotating and moving the casing. Through the hand-held setting, the user can easily rotate according to the required image position to further obtain the image and audio contents under the attitude.

In a specific embodiment, the processor 302 is also used to build a virtual 3D scene 311 that has a certain space and shape and includes a plurality of virtual objects 312, the virtual objects 312 specifically include background objects, foreground objects, sound sources, etc., and the position, appearance and sound change with time. The processor can also be used to change the attitude and heading of the virtual camera 313 and virtual head 314 in the center of the virtual 3D scene 311 and calculate the image to be transmitted and the sound to be played by the system at the current moment.

In a specific embodiment, the attitude sensor 301 can be a 6-axis attitude sensor containing 3-axis acceleration and 3-axis angular velocity, or a 3-axis geomagnetic sensor can be added to form a 9-axis sensor. The projection equipment 303 generally comprises a light source, a display component, an optical lens group and other components; available projection technologies include single-chip LCD (liquid crystal display) projection, 3LCD projection, DLP (digital light processing) projection, LCOS (reflective miniature LCD) projection, etc. For each technology, the specific components of the projection equipment are different, depending on the projection environment and image requirements.

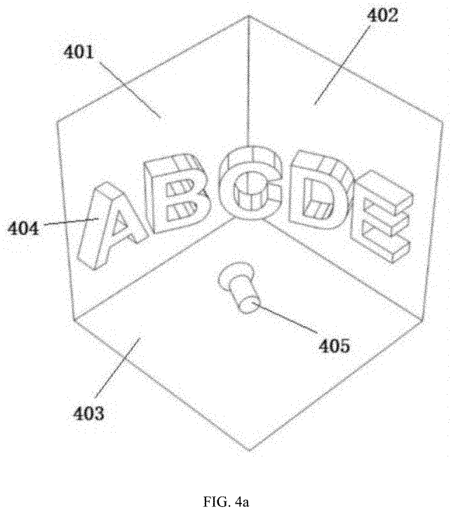

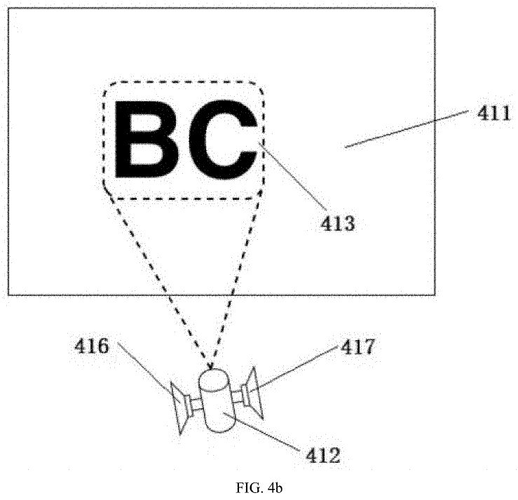

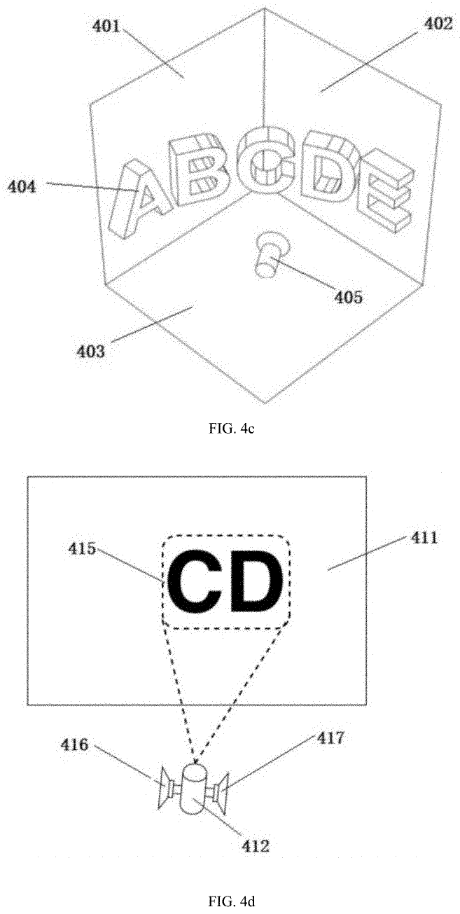

As shown in FIG. 4, FIG. 4a-4d are effect drawings of a projection system for immersive contents for one embodiment of the present invention. As shown in 4a to FIG. 4d, 411 is the wall in the real space, on which images can be projected; projection equipment 412 contains a hand-held casing corresponding to the whole device, and the user holds the projection equipment 412 to move and rotate in the space; 413 and 415 are images that the light emitted by projection equipment 412 shines on the wall 411; 416 is the left speaker, and 417 is the right speaker. FIG. 4a and FIG. 4c are schematic diagrams of virtual 3D scene established by the method of the present invention. As shown in the figure, 401, 402 and 403 are walls and ground in the virtual 3D scene, including 6 inner surfaces of the cube in total, and only 3 surfaces are shown here for clarity; the cube mapping projection is used in advance to project 360° panorama into 6 cube maps, which are mapped on the 6 inner surfaces of the cube as the background of the virtual scene. It should be realized that the virtual scene background is not limited to cube mapping, and a variety of projection methods can achieve the technical effect of the present invention. 404 is the foreground object in the virtual 3D scene, which contains five stereoscopic letter models of A, B, C, D and E arranged on a vertical curved surface; wherein, the letter C contains a sound source in the center; 405 are the virtual camera and the virtual head, which are always in the same position and located at the coordinates (0,0,1.5) in the specific embodiment; the field of view (FOV) of the virtual camera 405 is set to be the same as that of the projection equipment, preferably 30°; the aspect ratio of the imaging plane for the virtual camera is set to be the same as that of the projection equipment, preferably 4:3.

As shown in FIG. 4b, the user holds the projection equipment 412, points to the left of the center of the wall 411, and starts the projection equipment 412; the processor acquires the initial attitude and heading of the projection equipment 412, expresses the heading (yaw), pitch angle and roll as (−22.5,10,0) and records the initial absolute heading as −22.5°; the relative heading is calculated as −22.5−(−22.5)=0°, so the current relative attitude and heading are (0,10,0); as shown in FIG. 4a, the attitude and heading of the virtual camera and virtual head 405 are set to (0,10,0); the image of the virtual camera 405 is calculated by using 3D graphics technology, which is the BC image 413 in the dotted box; as shown in FIG. 4b, the projection equipment 412 projects the BC image 413 onto the left area of the center of the wall 411; the left and right channel audios received by the virtual head 405 under the current attitude and heading are calculated according to the HRTF based method, the left speaker 416 plays the left channel audio, and the right speaker 417 plays the right channel audio. After hearing the audios, the user perceives that the audio source is in the position of the letter C.

As shown in FIG. 4c, the user holds the projection equipment 412 to rotate to the right, and points to the right of the center of the wall 411; the processor acquires the initial attitude and heading (22.5,10,0) of the projection equipment 412 and calculates the relative heading as 22.5−(−22.5)=45°, so the current relative heading is (45,10,0); as shown in FIG. 4c, the attitude and heading of the virtual camera and virtual head are set to (45,10,0); the image of the virtual camera 405 is calculated, which is the CD image 415 in the dotted box; as shown in FIG. 4d, the projection equipment 412 projects the CD image 415 onto the right area of the center of the wall 411; the left and right channel audios received by the virtual head 405 under the status of FIG. 4c are calculated, the left speaker 416 plays the left channel audio, and the right speaker 417 plays the right channel audio. After hearing the audios, the user still perceives that the audio source is in the position of the letter C.

By comparing FIG. 4b with 4d, the scope of CD image 415 on the wall 411 moves to the right compared with the BC image 413, and an overlap exists in the scope of BC image 413. The position of C of CD image 415 on the wall 411 is exactly the same as that of C of BC image 413 on the wall 411. Therefore, the BC image 413 and the CD image 415 can be perfectly stitched into a big image. When the user holds the projection equipment 412 again and rotates it to the attitude and heading shown in FIG. 4b, the image projected by the projection equipment 412 will always be BC, which is consistent with picture 413 with the image.

In other words, as the user rotates the projection equipment 412, the image projected by the projection equipment 412 on the wall 411 is constantly changing. In the user's mind, the projected images at the current moment are stitched into a 360-degree panorama, which restores the visual factors such as background and foreground objects of the virtual 3D scene in FIG. 4a. As the user rotates the projection equipment 412, audios played by the left audio device 416 and the right audio device 417 are constantly changing. Due to the 3D stereo perception caused by differences in volume and spectrum, the audio source perceived by the user is always at the letter C, which restores the auditory factors of the virtual 3D scene in FIG. 4a. The contents provided in the embodiment of the present invention are brief descriptions. For those not mentioned in the embodiment, the relevant contents in the foregoing embodiments can be referred to.

### Embodiment 2

According to a projection method for immersive contents for one embodiment of the present invention, FIG. 5 shows a flow chart of a projection method for immersive contents according to one embodiment of the present invention. As shown in FIG. 5, the method 100 comprises the following steps:

S101b: Obtaining the attitude information of the projection equipment in the space, wherein, the attitude information includes the spatial attitude and heading of the projection equipment. The initial attitude information of the projection equipment facilitates to analyze what image needs to be output under the current attitude of the equipment.

In a specific embodiment, the attitude sensor can be a 6-axis attitude sensor containing 3-axis acceleration and 3-axis angular velocity, or a 3-axis geomagnetic sensor can be added to form a 9-axis sensor. The attitude sensor can directly output the attitude and heading of the sensor in the space to the processor, or only output the original acceleration, angular velocity and geomagnetic data, and the attitude is resolved by the processor. The Kalman filtering or other sensor fusion technologies are used for attitude resolving.

In a specific embodiment, the projection equipment generally comprises a light source, a display component and an optical lens group. Available projection technologies include single-chip LCD (liquid crystal display) projection, 3LCD projection, DLP (digital light processing) projection, LCOS (reflective miniature LCD) projection, etc. The suitable projection technology equipment is selected according to the projection environment and the image requirements.

S102b: Confirming the projected image under the current attitude information according to the preprocessed image or audio file. A panorama can be a static panorama preprocessed by various projection methods or an image obtained from a virtual 3D scene through real-time operation. The images under different attitude information can be determined by preprocessing to project the images under different attitudes.

S103b: Calculating the audio data under the current attitude information by using the head-related transformation function. The audio data to be played at the very moment is calculated according to the current spatial attitude and heading, including the audio of at least one channel or stereo audio of at least two channels. The output of audio data under different attitude information can bring users a more immersive sense and greatly improve the projection effect of immersive contents.

S104b: Outputting the projected image and the audio data under the current attitude information. The projected image and the audio data under the current attitude information are finally outputted onto the space surface by the projection equipment, and immersive projection contents including image picture and audio output are obtained.

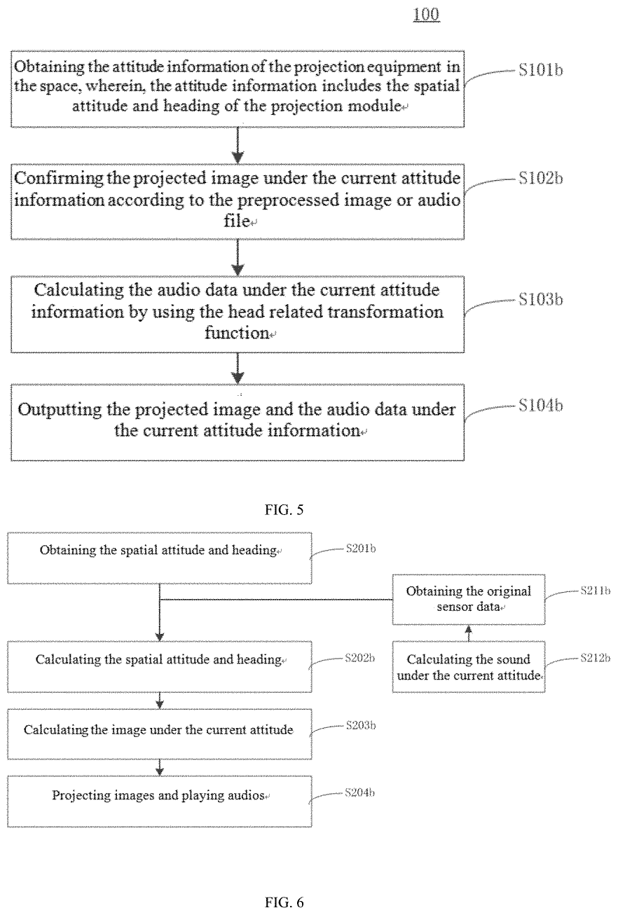

FIG. 6 shows a projection method for immersive contents according to a specific embodiment of the present invention. As shown in FIG. 6, the method includes the following steps:

S201b: Obtaining the current spatial attitude and heading of the equipment from the attitude sensor. The attitude information of the current equipment can be obtained according to the spatial attitude and heading, so as to obtain the output image or audio under the attitude information.

In a specific embodiment, the method for obtaining the spatial attitude and heading by use of a sensor includes the following steps:

S211b: Obtaining the current acceleration, angular velocity and geomagnetic data of the equipment from a 6-axis or 9-axis sensor. The current equipment parameter information can be obtained in real time through the multi-axis sensor.

S212b: Calculating the current spatial attitude and heading of the equipment by Kalman filtering and other sensor fusion technologies.

S202b: Calculating the image to be projected at the current moment according to the current spatial attitude and heading of the equipment. The transmitted image under the current spatial attitude and heading of the equipment can be obtained through the preprocessed image or video according to different spatial attitudes and headings.

S203b: Calculating the mono-channel audio or 3D stereo audio to be played at the current time according to the current spatial attitude and heading of the equipment. The audio data output at the current moment can be quickly calculated by using the head-related transformation function according to the current spatial attitude and heading of the equipment.

S204b: Projecting the current image by using the image obtained in S202b; playing the audio by using the audio obtained in S203b;

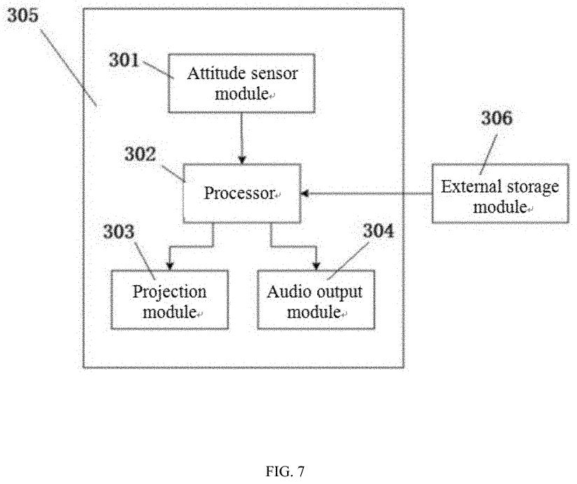

FIG. 7 shows a block diagram of a projection system for immersive contents according to a specific embodiment of the present invention. As shown in FIG. 7, the projection system comprises an attitude sensor 301, a processor 302 and projection equipment 303, wherein, the attitude sensor 301 can obtain the current attitude and heading of the system in the space; the processor module 302 has a certain arithmetic capability to calculate the image that the system needs to project under the current attitude and heading according to the attitude and heading of the system and send the image to the projection equipment 303, calculates the audio that the system needs to play under the current attitude and heading, and sends the audio to an audio output module 304 on the projection equipment 303; the projection equipment 303 can receive the image to be projected and project the image onto the surface of the real space by using the optical principle.

In a specific embodiment, the audio output module 304 can output the audio of at least one channel or stereo audio of at least two channels, which can be a speaker or an earphone. The system also comprises a casing 305, containing a part which can be held by hands or fixed to the body of the user or other moving parts. When the system is used, the attitude and heading of the attitude sensor 301 in the space change by rotating and moving the casing. Through the hand-held setting, the user can easily rotate according to the required image position to further obtain the image and audio contents under the attitude.

In a specific embodiment, the system also comprises an external storage module 306, which stores the immersive contents to be projected, which can be read by the processor 302, so as to calculate the projected image and played audio required currently.

In a specific embodiment, the attitude sensor 301 can be a 6-axis attitude sensor containing 3-axis acceleration and 3-axis angular velocity, or a 3-axis geomagnetic sensor can be added to form a 9-axis sensor. The attitude sensor 301 can directly output the attitude and heading of the sensor in the space, or only output the original acceleration, angular velocity and geomagnetic data to be operated by the processor 302, so as to obtain the attitude and heading of the attitude sensor 301 in the space. The projection equipment 303 generally comprises a light source, a display component, an optical lens group and other components; available projection technologies include single-chip LCD (liquid crystal display) projection, 3LCD projection, DLP (digital light processing) projection, LCOS (reflective miniature LCD) projection, etc. For each technology, the specific components of the projection equipment are different, depending on the projection environment and image requirements.

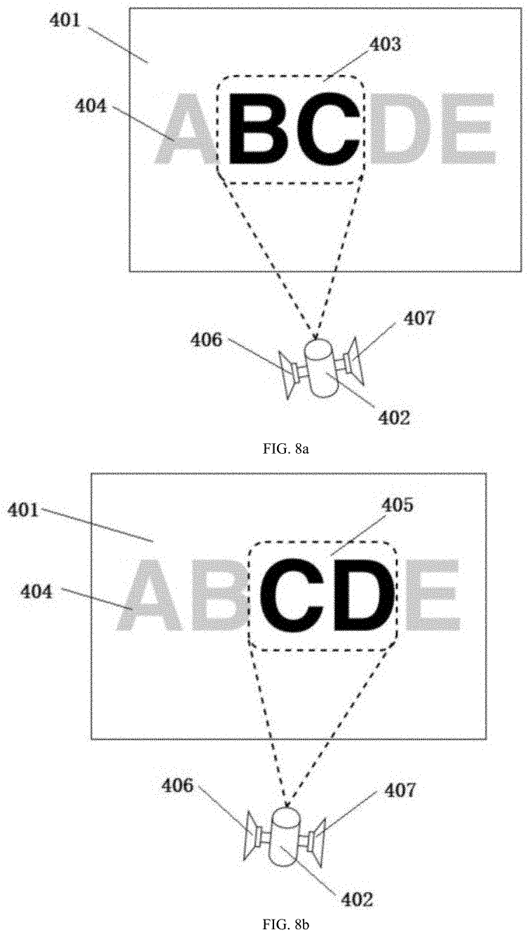

FIG. 8a to FIG. 8b are effect drawings of a projection system for immersive contents for one embodiment of the present invention. As shown in FIG. 8a to FIG. 8b, 401 is the wall in the real space, on which the image can be projected; 402 is the projection equipment, which corresponds to the whole system and contains a hand-held casing, and the user holds the projection equipment 402 to move and rotate in the space; 403 and 405 are the images that the light emitted by projection equipment 402 shines on the wall 401; 404 is the panorama to be projected, in which only ABCDE is shown; all images are 360° panoramas with a large space span, which cannot be completely displayed within the projection range of 403; 406 is the left speaker, and 407 is the right speaker.

As shown in FIG. 8a, the user holds the projection equipment 402 and points to the left of the center of the panorama 404; the projection equipment 402 calculates and projects the BC image 403 by the processing method as shown in FIG. 1 or FIG. 2; moreover, the left and right channel audios are calculated according to the HRTF based method, the left speaker 406 plays the left channel audio, and the right speaker 407 plays the right channel audio. After hearing the audios, the user perceives that the audio source is in the position of the letter C.

As shown in FIG. 8b, the user holds the projection equipment 402 to rotate to the right and points to the right of the center of the panorama 404; the projection equipment 402 calculates and projects the CD image 405 by the processing method as shown in FIG. 1 or FIG. 2; the left and right channel audios are calculated according to the HRTF based method and played respectively by the left speaker 406 and the right speaker 407. After hearing the audios, the user perceives that the audio source is still in the position of the letter C. The scope of CD image 405 on the wall 401 moves to the right compared with the BC image 403, and an overlap exists in the scope of BC image 403. The position of C of CD image 405 on the wall 401 is exactly the same as that of C of BC image 403 on the wall 401. Therefore, the BC image 403 and the CD image 415 can be perfectly stitched into a big image. When the user holds the projection equipment 402 again and rotates it to the attitude and heading shown in FIG. 4a, the image projected by the projection equipment 402 will always be BC image 403. In other words, as the user rotates the projection equipment 402, the image projected by the projection equipment 402 on the wall 401 is constantly changing, and only part of panorama 404 is displayed at any moment. In the user's mind, the projected images at every moment are stitched into a 360-degree static panoramic image 404. As the user rotates the projection equipment 402, audios played by the left audio device 406 and the right audio device 407 are constantly changing. Due to the 3D stereo perception caused by differences in volume and spectrum, the audio source perceived by the user is always at the letter C.

The contents provided in the embodiment of the present invention are brief descriptions. For those not mentioned in the embodiment, the relevant contents in the foregoing embodiments can be referred to.

### Embodiment 3

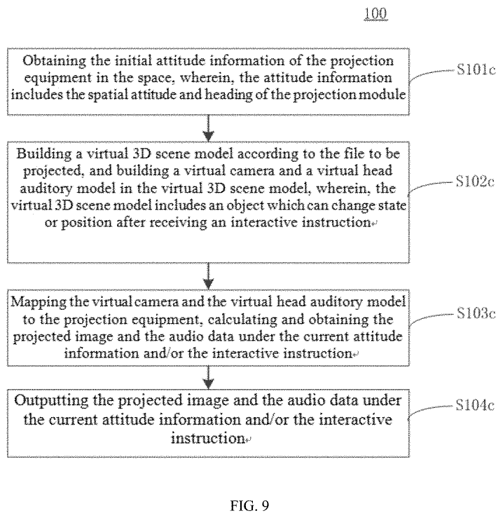

According to an interactive method for immersive contents for one embodiment of the present invention, FIG. 9 shows a flow chart of an interactive method for immersive contents according to one embodiment of the present invention. As shown in FIG. 9, the method comprises the following steps:

S101c: Obtaining the initial attitude information of the projection equipment in the space, wherein, the attitude information includes the spatial attitude and heading of the projection equipment. The initial attitude information of the projection equipment facilitates to analyze what image needs to be output under the current attitude of the equipment.

In a specific embodiment, the attitude information can be obtained by the attitude sensor arranged on the projection equipment. The attitude sensor can be a 6-axis attitude sensor containing 3-axis acceleration and 3-axis angular velocity, or a 3-axis geomagnetic sensor can be added to form a 9-axis sensor. When the 6-axis attitude sensor is used, the accurate attitude of the equipment and the heading (also known as yaw) relative to the initial state can be obtained; when the 9-axis attitude sensor is used, the accurate attitude of the equipment and the absolute heading relative to the Earth can be obtained.

In a specific embodiment, the projection equipment generally comprises a light source, a display component and an optical lens group. Available projection technologies include single-chip LCD (liquid crystal display) projection, 3LCD projection, DLP (digital light processing) projection, LCOS (reflective miniature LCD) projection, etc. The suitable projection technology equipment is selected according to the projection environment and the image requirements.

S102c: Building a virtual 3D scene model according to the file to be projected, and building a virtual camera and a virtual head auditory model in the virtual 3D scene model, wherein, the virtual 3D scene model includes an object which can change state or position after receiving an interactive instruction. The built virtual 3D scene model can be used to pre-calculate and obtain the image or audio output relative to the virtual camera and the virtual head auditory model as well as the image or audio output of the virtual camera and the virtual head auditory model under the interactive instruction, facilitating to output in the projection equipment.

In a specific embodiment, a virtual 3D scene model is built according to the image and audio information in the file to be projected, and a background object, a foreground object and a sound source are contained in the scene; the positions and appearances of the background object and foreground object change with time; a virtual camera and a virtual head auditory model are built, which are located in the center of the virtual scene and whose initial attitude and heading are default attitude and heading. Preferably, the object(s) which can change state or position after receiving an interactive instruction is/are one or more of the foreground objects. The attribute of state or position change of the foreground object enables an interactive projection experience. It should be recognized that the background object can be similarly set to the property of state or position change to achieve the technical effects of the present invention.

S103c: Mapping the virtual camera and the virtual head auditory model to the projection equipment, calculating and obtaining the projected image and the audio data under the current attitude information and/or the interactive instruction. The image and audio information in the virtual camera and the virtual head auditory model can be directly obtained on the projection equipment through the mapping relation, and the corresponding image and audio can be projected according to different attitude information and the interactive instructions.

In a specific embodiment, the virtual camera and the virtual head auditory model are mapped to the projection equipment as follows: the field of view of the virtual camera is the same as that of the projection equipment, the aspect ratio of the imaging plane for the virtual camera is the same as that of the projected image on the projection equipment; the virtual head auditory model is built, and the initial position, attitude and heading of the virtual head auditory model are the same as that of the virtual camera.

In a specific embodiment, the image of the virtual scene in the virtual camera is calculated by the computer 3D graphics; the audio synthesized in the virtual head auditory model by sounds from sound sources in the virtual scene are calculated according to the method based on head-related transformation function (HRTF). In a specific embodiment, the projected images under the interactive instructions are calculated as follows: Responding to the axis of the virtual camera to intersect with the foreground object, which is set to an object capable of changing the state or position after receiving the interactive instruction, and recording the object as a virtual object to be operated. The following methods can be used to determine the intersection between the axis of the virtual camera and the foreground object: making a ray along the axis direction of the camera to calculate whether the ray intersects with the virtual object in the virtual scene; using the surrounding sphere of the virtual object for intersection detection. The surrounding sphere is a sphere with the position of the virtual object as the center of the sphere and with a preset radius. The method for judging intersection is to calculate the distance between the center of the surrounding sphere the axis direction of the camera. If the distance is less than the radius of the surrounding sphere, the axis of the virtual camera will intersect with the foreground object; otherwise, the axis of the virtual camera will not intersect with the foreground object.

Responding to the user to send the interactive instruction, and switching the virtual object to be operated to an interactive state if the virtual object to be operated exists, wherein, the interactive state includes morphological change, position change, size change or their combination. In a specific embodiment, the interactive state can be dragging state, and the display effect of the object in the dragging state is 1.2 times of its original size.

Responding to the user to release the interactive instruction, restoring the virtual object to be operated to the normal state if the virtual object to be operated exists, and emptying the record of the virtual object to be operated.

S104c: Outputting the projected image and the audio data under the current attitude information and/or the interactive instruction. Finally, the projected image and the audio data under the current attitude information are outputted on the space surface through the projection equipment. At the same time, the projected image and audio output are changed according to the interactive instruction of the user to obtain an immersive interactive experience.

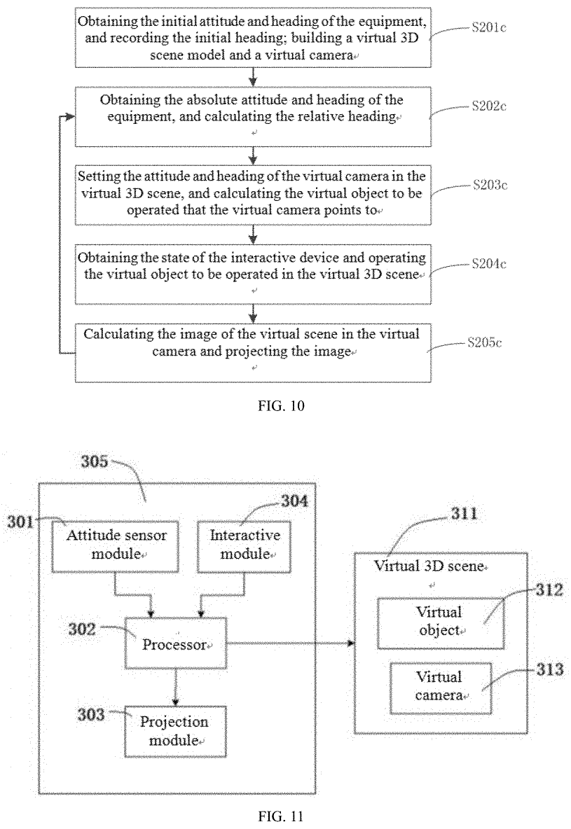

FIG. 10 shows an interactive method for immersive contents according to a specific embodiment of the present invention. As shown in FIG. 10, the method includes the following steps:

S201c: Obtaining the initial attitude and heading of the equipment, and recording the initial heading; building a virtual 3D scene model and a virtual camera. After the system is started, the initial attitude and heading of the equipment are obtained from the attitude sensor, and the initial heading of the equipment is recorded.

In a specific embodiment, a virtual 3D scene model is built, background objects and foreground objects are contained in the scene, and the positions and appearances of the background objects and the foreground objects can be changed with time; some foreground objects are interactive, and other foreground objects are not interactive. By building interactive objects, interactive operations can be achieved.

In a specific embodiment, a virtual camera is established, which is located in the center of the virtual scene and whose initial attitude and heading are the default attitude and heading; the field of view of the virtual camera is the same as that of the projection equipment, and the aspect ratio of the imaging plane of the virtual camera is the same as that of the projection equipment.

S202c: Obtaining the current absolute attitude and heading of the equipment, and calculating the relative heading. Optionally, the equipment heading relative to the initial state is calculated according to the initial heading recorded in S201c.

S203c: Setting the attitude and heading of the virtual camera in the virtual 3D scene, and calculating the virtual object to be operated that the virtual camera points to. The attitude and heading of the virtual camera are the attitude and heading of the virtual camera obtained in S202c.

In a specific embodiment, the virtual objects intersecting with the axis direction of the virtual camera in the virtual 3D scene are calculated, and one of the interactive virtual objects is selected and recorded as the virtual object to be operated.

S204c: Obtaining the state of the interactive device and operating the virtual object to be operated in the virtual 3D scene. If the user performs an interactive operation on the interactive device and the virtual object to be operated exists, the state and position of the virtual object to be operated will be changed.

S205c: Calculating the image of the virtual scene in the virtual camera and projecting the current image.

Repeat S203c, so that the projection equipment of the present invention can change the projected image in real time with the change of attitude and heading.

In the above method, the projection and interaction of the virtual 3D scene are completed simultaneously on the same equipment, that is, the interactive operation of the virtual object is calculated while the immersive projection contents are calculated. The change of projection contents in the method of the present invention is consistent. In essence, images projected in different directions can be stitched into a complete 360° panoramic image. The projection lens can only project part of the area each time, and the projection contents can be changed by changing the spatial attitude and heading of the projection lens. When the immersive panoramic image is explored by the projection equipment, the virtual objects that the projection lens points to are operated by the interactive device in a simple interactive way.

FIG. 11 shows a block diagram of an interactive system for immersive contents according to a specific embodiment of the present invention. As shown in FIG. 11, the projection system comprises an attitude sensor 301, a processor 302, projection equipment 303 and an interactive module 304, wherein, the attitude sensor 301 can obtain the current attitude and heading of the system in the space; the processor module 302 has a certain arithmetic capability, obtains the attitude and heading of the system in the space, obtains the attitude and heading of the system in the space, and judges which virtual object in the virtual 3D scene needs to be operated, obtains the current status of the interactive module 304 to make changes to virtual objects, calculates the image that the system needs to project under the current attitude and heading and send the image to the projection equipment 303, calculates the audio that the system needs to play under the current attitude and heading, and sends the audio to an audio output module on the projection equipment 303; the projection equipment 303 can receive the image to be projected and project the image onto the surface of the real space by using the optical principle.

In a specific embodiment, the audio output module can output the audio of at least one channel or stereo audio of at least two channels, which can be a speaker or an earphone. The system also comprises a casing, containing a part which can be held by hands or fixed to the body of the user or other moving parts. When the system is used, the attitude and heading of the attitude sensor 301 in the space change by rotating and moving the casing. Through the hand-held setting, the user can easily rotate according to the required image position to further obtain the image and audio contents under the attitude.

In a specific embodiment, the processor 302 is also used to build a virtual 3D scene 311, which has a certain space and shape and comprises a plurality of virtual objects 312, wherein, the virtual objects 312 specifically include background objects, foreground objects, audio sources, etc., whose position, appearance and sound can be changed with time, and some of which are marked as interactive. The processor 302 can also be used to change the attitude and heading of the virtual camera 313 and the virtual head 314 located in the center of the virtual 3D scene 311 and calculate the images projected and sounds played by the system at the current moment as well as the virtual objects to be interacted with.

In a specific embodiment, the processor modules are also configured for responding to the axis of the virtual camera to intersect with the foreground object, which is set to an object capable of changing the state or position after receiving the interactive instruction, and recording the object as a virtual object to be operated; responding to the user to send the interactive instruction, and switching the virtual object to be operated to an interactive state if the virtual object to be operated exists, wherein, the interactive state includes morphological change, position change, size change or their combination; responding to the user to release the interactive instruction, restoring the virtual object to be operated to the normal state if the virtual object to be operated exists, and emptying the record of the virtual object to be operated.

In a specific embodiment, the attitude sensor 301 can be a 6-axis attitude sensor containing 3-axis acceleration and 3-axis angular velocity, or a 3-axis geomagnetic sensor can be added to form a 9-axis sensor. The projection equipment 303 generally comprises a light source, a display component, an optical lens group and other components; available projection technologies include single-chip LCD (liquid crystal display) projection, 3LCD projection, DLP (digital light processing) projection, LCOS (reflective miniature LCD) projection, etc. For each technology, the specific components of the projection equipment are different, depending on the projection environment and image requirements.

Compared with the problems existing in the prior art, such as a higher number of projectors, additional image acquisition equipment for completing interaction, large volume, high cost, pre installation and calibration, less applicable occasions, large number of operations for computer vision algorithm and inapplicability to weak operational capability equipment, the present invention can complete the interaction with the immersive contents by using a single small projector, the equipment is small in size, the hardware cost is low, the projector is not required to be installed, can be used flexibly at any time and are suitable for families, schools and other occasions, the number of operations for the used technology and methods is small, and the projector occupies less memory and other system resources and is suitable for low cost equipment with weak operational capability, such as children's toys, etc.

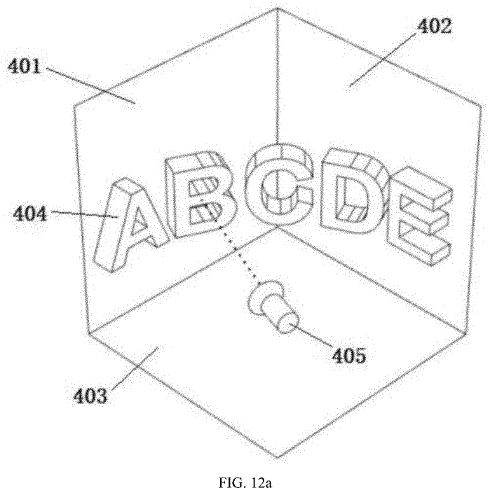

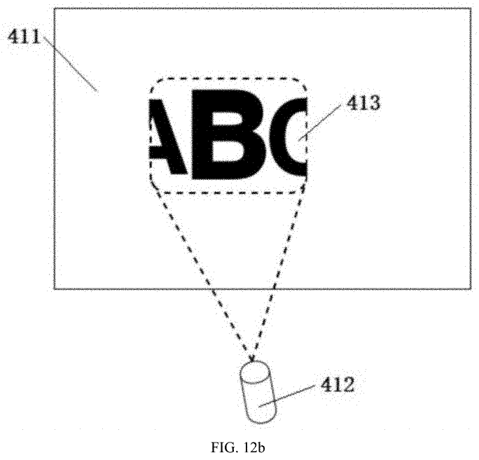

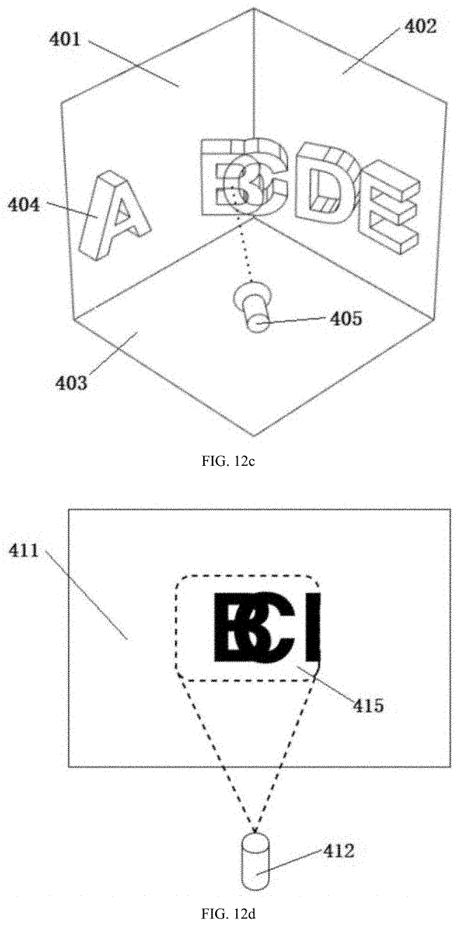

As shown in FIG. 12, FIG. 12a-12c are effect drawings of a projection system for immersive contents for one specific embodiment of the present invention. As shown in FIG. 12a to FIG. 12d, 411 is the wall in the real space, on which images can be projected; projection equipment 412 contains a hand-held casing corresponding to the whole device, and the user holds the projection equipment 412 to move and rotate in the space; a button is arranged on the projection equipment 412 as an interactive device; 413 and 415 are images that the light emitted by projection equipment 412 shines on the wall 411.

First, as shown in FIG. 12a, 401, 402 and 403 are walls and ground in the virtual 3D scene, including 6 inner surfaces of the cube in total, and only 3 surfaces are shown here for clarity; the cube mapping projection is used in advance to project 360° panorama into 6 cube maps, which are mapped on the 6 inner surfaces of the cube as the background of the virtual scene. It should be realized that the virtual scene background is not limited to cube mapping, and a variety of projection methods can achieve the technical effect of the present invention. Five foreground objects 404 in the virtual 3D scene contain five stereoscopic letter models of A, B, C, D and E arranged on a vertical curved surface; in a specific embodiment, five objects are marked as interactive objects, and the interactive operation supported by the objects is to move along the vertical curved surface; the virtual camera 405 is located inside the cube and located at the coordinates (0,0,1.5) in the specific embodiment; the field of view (FOV) of the virtual camera 405 is set to be the same as that of the projection equipment 412, which is 30°; the aspect ratio of the imaging plane for the virtual camera 405 is set to be the same as that of the projection equipment 412, which is 4:3.

As shown in FIG. 12b, the user holds the projection equipment 412, points to the left of the center of the wall 411 and starts the projection equipment 412; the processor acquires the initial attitude and heading of the projection equipment 412, expresses the heading (yaw), pitch angle and roll as (−22.5,10,0) and records the initial absolute heading as −22.5°; the relative heading is calculated as −22.5−(−22.5)=0°, so the current relative attitude and heading are (0,10,0); as shown in FIG. 4a, the attitude and heading of the virtual camera 405 are set to (0,10,0); A ray is made along the axis direction of the virtual camera 405 from the location of the virtual camera 404 to calculate whether the ray intersects with the virtual object in the virtual scene; in the embodiment, the surrounding sphere of the virtual object is used for intersection detection. The surrounding sphere is a sphere with the position of the virtual object as the center of the sphere and with a preset radius. The method for judging intersection is to calculate the distance between the center of the surrounding sphere the axis direction of the camera. If the distance is less than the radius of the surrounding sphere, the axis of the virtual camera will intersect with the foreground object; In a specific embodiment, the virtual object letter B intersects with the ray, and the virtual object is an interactive object, so the object is recorded as the virtual object to be operated; at this point, the user presses the interaction button on the projection equipment 412, the system obtains that the status of the interaction button changes from released to pressed, and the virtual object to be operated exists, so the virtual object to be operated is switched to the dragging state; the virtual object in the dragging state is displayed with an optional size 1.2 times the original size; The image of the virtual camera 405 calculated according to 3D graphics technology is the ABC image 413 in the dotted box, the virtual object that the virtual camera 405 faces is the letter B, the letter B is also in the center of the projected image, and the size of letter B is 1.2 times the letters A and C; as shown in FIG. 4b, the projection equipment 412 projects the ABC image 413 onto the left area of the center of the wall 411.

As shown in FIG. 12c, the user holds the projection equipment 412, rotates it to the right, and points to the middle direction of the wall 411; the processor obtains the current initial attitude and heading (−5,10,0) of the projection equipment 412 and calculates the relative heading as 5−(−22.5)=17.5°, so the current relative heading is (17.5,10,0); as shown in FIG. 12c, the attitude and heading of the virtual camera are set to (17.5,10,0); as the virtual object B is currently in the dragging state, its position changes with the virtual camera 405. The position change method is to keep the relative position of the axis of the virtual camera 405 and the virtual object B unchanged, move the virtual object B along the curved surface and rotate the virtual object B, and move the object to the position where the object partially overlaps with the virtual object C. At this point, the user releases the interaction button on the projection equipment 412, and the system obtains that the status of the interaction button changes from pressed to released, and the virtual object to be operated exists, so the virtual object to be operated is switched to the normal state, the size of the object changes to the original size, and the record for the virtual object to be operated is cleared.

The image of the virtual camera 405 is calculated as the BC image 415 in the dotted box, and the letter B is still in the center of the projected image, and the size of B is the same as that of C; as shown in FIG. 4d, the projection equipment 412 projects the BC image 415 onto the middle area of the wall 411.

As the user rotates the projection equipment 412, the image projected by the projection equipment 412 onto the wall 411 is constantly changing. In the user's mind, the projected images at every moment are stitched into a 360-degree panorama, which restores the visual factors such as background and foreground objects of the virtual 3D scene in FIG. 12a. The user can drag the virtual object in the virtual 3D scene by operating the interaction button to change the position of the virtual object in the virtual 3D scene, and the change is reflected on the projected image in real time.

The contents provided in the embodiment of the present invention are brief descriptions. For those not mentioned in the embodiment, the relevant contents in the foregoing embodiments can be referred to.

### Embodiment 4

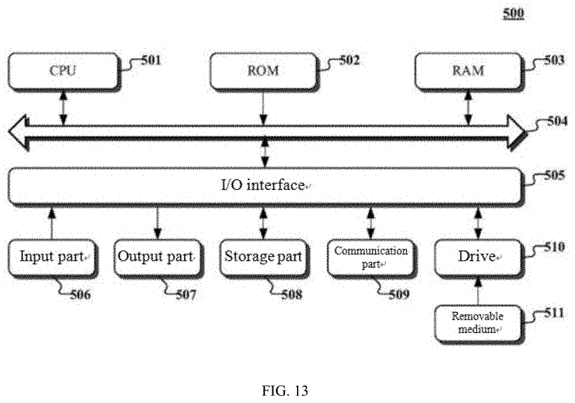

Refer to FIG. 13. FIG. 13 shows a structural diagram of a computer system suitable for the implementation of electronic equipment for one embodiment of the present invention. The electronic equipment shown in FIG. 13 is only an example and should not impose any restrictions on the functionality and scope of use of the embodiment for the present invention.

As shown in FIG. 13, the computer system 500 comprises a central processing unit (CPU) 501, which can perform various appropriate actions and processing according to programs stored in ROM 502 or loaded from a storage part 508 into RAM 503. RAM 503 also stores a variety of programs and data required for the operations of system 500. CPU 501, ROM 502 and RAM 503 are connected mutually through a bus 504. An I/O interface 505 is also connected to the bus 504.

The following components are connected to the I/O interface 505: an input part 506 including a keyboard and a mouse; an output part 507 including an LCD and speakers; a storage part including a hard disk 508; and a communication part 509 including an LAN card, a modem and other network interface cards. The communication part 509 performs communication processing over a network such as Internet. A drive 510 is also connected to the I/O interface 505 as required. Removable media 511, such as a disk, an optical disk, a magneto-optical disk, a semiconductor memory, etc., are installed on the drive 510 as required, so that computer programs read from the removable media 511 can be easily installed into the storage part 508 as required.

In particular, the process described by reference to the flow chart can be implemented as a computer software program according to the embodiment disclosed in the present invention. For example, the embodiment disclosed in the present invention comprises a computer program product, wherein, the computer program product comprises a computer program hosted on a computer readable storage medium, and the computer program contains program codes for performing the method shown in the flow chart. In such embodiment, the computer program can be downloaded and installed from the network through the communication part 509, and/or installed from the removable media 511. When the computer program is executed by the central processing unit (CPU) 501, the above functions defined in the method of the present invention are performed. It should be noted that the computer readable storage medium in the present invention can be a computer readable signal medium or a computer readable storage medium or any combination of the two. For example, the computer readable storage medium can be, but not be limited to, an electrical, magnetic, optical, electromagnetic, infrared or semiconductor system, device or component or any combination of the above. More specific example of the computer readable storage medium can include, but not be limited to an electrical connection with one or more wires, a portable computer disk, a hard disk, a RAM, a ROM, an erasable programmable read-only memory (EPROM or flash memory), an optical fiber, a CD-ROM, an optical storage device or a magnetic storage device or any combination of the above. In the present invention, the computer readable storage medium can be any tangible medium containing or storing a program which can be used by or in combination with an instruction execution system, appliance or device. In the present invention, the computer readable signal medium can include data signals transmitted in a base band or as part of a carrier, which carries computer readable program codes. The data signals transmitted can be in various forms, including but not limited to electromagnetic signals, optical signals or any suitable combination of the above. The computer readable signal medium can also be any computer readable storage medium other than the computer readable storage medium which can send, propagate or transmit programs intended for use by or in combination with the instruction execution system, appliance or device. The program codes contained on the computer readable storage medium can be transmitted by any suitable medium, including but not limited to wireless, wire, optical cable or RF medium or any suitable combination of the above.

The computer program codes used to perform the operations of the present invention can be written in one or more programming languages or a combination thereof. The programming languages include object-oriented programming languages such as Java, Smalltalk and C++ as well as conventional procedural programming languages such as C language or similar programming languages. The program codes can be executed entirely on a subscriber computer, partially on the subscriber computer, as a separate package, partially on the subscriber computer and partially on a remote computer, or entirely on a remote computer or server. In the case of remote computer, the remote computer can be connected to the subscriber computer through any type of network, including a local area network (LAN) or wide area network (WAN), or the remote computer can be connected to an external computer (through the Internet by using an Internet service provider).

The flow charts and block diagrams in the Drawings illustrate the possible system structures, functions and operations realized by the system, method and computer program product for the embodiments of the present invention. In this regard, each box in the flow charts and the block diagrams represents a module, program segment or part of codes, which contains one or more executable instructions for implementing specified logical functions. It should also be noted that the functions indicated in the boxes may occur in a different order than those indicated in the drawings in some alternative implementations. For example, two consecutive boxes can be executed essentially in parallel, or sometimes they can be executed in reverse order, depending on the functions involved. It should also be noted that each box in the block diagrams and/or the flow charts and the combination of boxes in the block diagrams and/or the flow charts can be realized by a special hardware-based operating system for performing the specified functions or operations or a combination of special hardware and computer instructions.

The modules described in the embodiment of the present invention can be implemented by software or hardware.

On the other hand, the present invention also provides a computer readable storage medium, which can be included in the electronic equipment described in the above embodiments, or exists alone and is not assembled into the electronic equipment. The computer readable storage medium hosts one or more programs. When one or more programs are executed by the electronic equipment, the electronic equipment obtains the attitude information of projection equipment in the space, including the spatial attitude and heading of the projection equipment; confirms the projected image under the current attitude information according to the preprocessed image or audio file; calculates the audio data under the current attitude information by the head-related transformation function; outputs the projected image and the audio data under the current attitude information.

The contents provided in the embodiment of the present invention are brief descriptions. For those not mentioned in the embodiment, the relevant contents in the foregoing embodiments can be referred to.

Finally, it should be noted that the above embodiments are only used to illustrate the technical proposal of the present invention, but not to limit it. Notwithstanding the detailed description of the present invention with reference to the foregoing embodiments, the ordinary technicians in the field should understand that they may modify the technical proposal recorded in the foregoing embodiments or make equivalent substitutions of some or all of the technical features thereof. Such modification or substitution shall not separate the essence of the corresponding technical proposal from the scope of technical proposal for each embodiment of the present invention, and shall be covered by the claims and specification of the present invention.

1. A projection method for immersive contents, wherein:
S1a: Obtaining the attitude information of the projection equipment in the space, wherein, the attitude information includes the spatial attitude and heading of the projection equipment;
S2a: Building a virtual 3D scene model according to the file to be projected, and building a virtual camera and a virtual head auditory model in the virtual 3D scene model;
S3a: Mapping the virtual camera and the virtual head auditory model to the projection equipment, calculating and obtaining the projected image and the audio data under the current attitude information; and
S4a: Outputting the projected image and the audio data under the current attitude information; or
S1b: Obtaining the attitude information of projection equipment in the space, wherein, the attitude information includes the spatial attitude and heading of the projection equipment;
S2b: Confirming the projected image under the current attitude information according to the preprocessed image or audio file;
S3b: Calculating the audio data under the current attitude information by using the head-related transformation function; and
S4b: Outputting the projected image and the audio data under the current attitude information; or
S1c: Obtaining the attitude information of projection equipment in the space, wherein, the attitude information includes the spatial attitude and heading of the projection equipment;
S2c: Building a virtual 3D scene model according to the file to be projected, and building a virtual camera and a virtual head auditory model in the virtual 3D scene model, wherein, the virtual 3D scene model includes an object which can change state or position after receiving an interactive instruction;
S3c: Mapping the virtual camera and the virtual head auditory model to the projection equipment, calculating and obtaining the projected image and/or audio data under the current attitude information and/or the interactive instruction; and
S4c: Outputting the projected image and the audio data under the current attitude information and/or the interactive instruction.

2. The projection method for immersive contents according to claim 1, wherein the 3D scene model comprises a foreground object, a background object and a sound source, and the positions and appearances of the foreground object and the background object change as time changes.

3. The projection method for immersive contents according to claim 2, wherein the object(s) set to change the state or position after receiving the interactive instruction is/are one or more of the foreground objects.

4. The projection method for immersive contents according to claim 1, wherein the preprocessed image or audio file includes a static panorama or a panoramic video.

5. The projection method for immersive contents according to claim 1, wherein the attitude information in the step S1a, S1b or S1c is obtained by an attitude sensor set on the projection equipment through the attitude estimation, which is based on the Kalman filter sensor fusion algorithm.

6. The projection method for immersive contents according to claim 5, wherein the attitude sensor is a 6-axis or 9-axis sensor, comprising an acceleration sensor, an angular velocity sensor and a geomagnetic data sensor.

7. The projection method for immersive contents according to claim 5, wherein the virtual camera has the same field of view and aspect ratio of the imaging plane as the projection equipment, and the attitude information of the virtual camera and the virtual head auditory model is the same as that of the projection equipment.

8. The projection method for immersive contents according to claim 1, wherein the projected image under the current attitude information is obtained by computer 3D graphics computing, and the audio data is obtained by head-related transformation function computing.

9. The projection method for immersive contents according to claim 1, wherein the projection equipment rotates in the space to project the projected image and the audio data at the corresponding position of the preprocessed image or audio file at different positions in the space.

10. The projection method for immersive contents according to claim 1, wherein in the Step S3c, the projected image and/or audio data under the interactive instruction are calculated as follows:
Responding to the axis of the virtual camera to intersect with the foreground object, which is set to an object capable of changing the state or position after receiving the interactive instruction, and recording the object as a virtual object to be operated;
Responding to the user to send the interactive instruction, and switching the virtual object to be operated to an interactive state if the virtual object to be operated exists, wherein, the interactive state includes morphological change, position change, size change or their combination;
Responding to the user to release the interactive instruction, restoring the virtual object to be operated to the normal state if the virtual object to be operated exists, and emptying the record of the virtual object to be operated.

11. A computer readable storage medium, on which one or more computer programs are stored, wherein the projection method for immersive contents according to claim 1 is executed when the one or more computer programs are executed by a computer processor.

12. A projection system for immersive contents, wherein the system comprises:
Projection equipment for receiving the image to be projected and transmitting the image to the space surface;
An attitude sensor module used for obtaining the attitude information of the projection equipment in the current space, wherein, the attitude information includes the spatial attitude and heading of the projection equipment; and
A first processor module used for building a virtual 3D scene model according to the file to be projected, building a virtual camera and a virtual head auditory model in the virtual 3D scene model, Mapping the virtual camera and the virtual head auditory model to the projection equipment, obtaining the projected image and the audio data under the current attitude information, and determining the projected image of the projection equipment under the current attitude information according to the different attitude information when the projection equipment rotates in the space; or
A second processor module used for determining the projected image of the projection equipment under the current attitude information according to different attitude information of the projection equipment when the projection equipment rotates in space; or
A third processor module used for building a virtual 3D scene model according to the file to be projected, and building a virtual camera and a virtual head auditory model in the virtual 3D scene model, wherein, the virtual 3D scene model includes an object which can change the state or position after receiving an interactive instruction; mapping the virtual camera and the virtual head auditory model to the projection equipment, obtaining the projected image and the audio data under the current attitude information and/or the interactive instruction, and determining the projected image and the audio data of the projection equipment under the current attitude information and/or the interactive instruction according to the different attitude information and/or the interactive instruction when the projection equipment rotates in the space.

13. The projection system for immersive contents according to claim 12, wherein the projection equipment also comprises an audio output module for outputting the audio of at least one channel or stereo audio of at least two channels.

14. The projection system for immersive contents according to claim 12, wherein the system also comprises:
An interactive module used for receiving the interactive instructions made by the user.

15. The projection system for immersive contents according to claim 14, wherein the interactive module comprises a button, a rocker or a handle arranged on the system, and the interactive instructions include click, toggle or different button instructions.

16. The projection system for immersive contents according to claim 12, wherein the third processor module is also used for:
Responding to the axis of the virtual camera to intersect with the foreground object, which is set to an object capable of changing the state or position after receiving the interactive instruction, and recording the object as a virtual object to be operated;
Responding to the user to send the interactive instruction, and switching the virtual object to be operated to an interactive state if the virtual object to be operated exists, wherein, the interactive state includes morphological change, position change, size change or their combination;
Responding to the user to release the interactive instruction, restoring the virtual object to be operated to the normal state if the virtual object to be operated exists, and emptying the record of the virtual object to be operated.
